(19) United States
(12) Patent Application Publication
(10) Pub. No.: US 2010/0316030 A1
(43) Pub. Date: Dec. 16, 2010

(54) TECHNIQUES FOR SUPPORTING MULTIPLE PROTOCOLS IN WIRELESS NETWORKS

(76) Inventors: Muthaiah Venkatachalam, Beaverton, OR (US); Aran Bergman, Givatayim (IL)

Correspondence Address: INTEL CORPORATION;c/o CPA Global, P.O. BOX 52050, MINNEAPOLIS, MN, 55402, US

(21) Appl. No.: 12/761,446

(22) Filed: Apr. 16, 2010

Related U.S. Application Data
(60) Provisional application No. 61/173,204, filed on Apr. 28, 2009.

(51) Int. Cl. H04W 80/00

(52) U.S. Cl. 370/338

(57) ABSTRACT

An embodiment of the present invention provides a method of supporting multiple protocols in a wireless network operating according to an Institute for Electronic and Electrical Engineers IEEE) 802.16 standard, comprising adding a new convergence sub layer (CS) type in which an extra field is added to an 802.16 service data unit (SDU) to indicate which higher layer protocol is carried in a 802.16 SDU payload.

### CROSS REFERENCE TO RELATED APPLICATIONS

The present application claims the benefit of U.S. provisional application Ser. No. 61/173,204, filed Apr. 28, 2009, (docket # P30516Z) entitled “Supporting Multiple protocols on a single 16m flow of an MS”, the entire content of which is incorporated by reference herein.

### BACKGROUND

In wireless networks, such as but not limited to, wireless networks operating according to an Institute for Electronic and Electrical Engineers IEEE) 802.16 standard (also may be referred to herein as a WiMAX network), a connection is shared between all packets that carry the same protocol and have the same quality of service (QoS) requirements (and should use the same QoS parameters). That is, if a MS has to support IPv6, IPv4 and Ethernet packets, it would have to use 3 different connections, although all of them may require BE scheduling type.

Thus, a need exists for improved techniques for supporting multiple protocols in wireless networks.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of a MAC SDU according to an embodiment of the present invention; and

FIG. 2 provides a system according to embodiments of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the preset invention may be practiced without these specific details. In other instances, well-known methods, procedures, components and circuits have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Embodiments of the present invention provide adding a protocol type field to the wireless network (such as WiMAX) packet (for a new type of convergence sublayer [CS]), to enable sending several different protocols over the same flow.

In the 802.16m protocol, for example, it would be advantageous to be able to multiplex several protocols (e.g., RoHC, IPv4, IPv6, Ethernet) on the same flow. In that way, a set of quality of service (QoS) parameters will be associated with a FID, regardless of the protocol(s) it can carry.

Embodiments of the present invention provide adding a new CS type in which an extra field is added to the WiMAX (it is understood that the present invention is not limited in this respect) SDU (much like the PHSI field is added to WiMAX SDUs on flows where PHS is enabled) to indicate which higher layer protocol is carried in the WiMAX SDU payload. Embodiments of the present invention may provide a CS specification parameter specifying the CS that the connection being set up shall use the following.

| Type | Length | Value | Scope |
|---|---|---|---|
| [145/146].28 | 1 | 1: Packet, IPv4 | DSA-REQ |
| | | 2: Packet, IPv6 | |
| | | 3: Packet, IEEE 802.3/Ethernet^{a} | |
| | | 4: Reserved | |
| | | 5: Packet, IPv4 over IEEE 802.3/ | |
| | | Ethernet^{a} | |
| | | 6: Packet, IPv6 over IEEE 802.3/ | |
| | | Ethernet^{a} | |
| | | 7: Reserved | |
| | | 8: Reserved | |
| | | 9: ATM | |
| | | 10: Reserved | |
| | | 11: Reserved | |
| | | 12: Reserved | |
| | | 13: Reserved | |
| | | 14: Packet, IP^{b} | |
| | | 15: Multiprotocol flow | |
| | | 16-255 Reserved | |

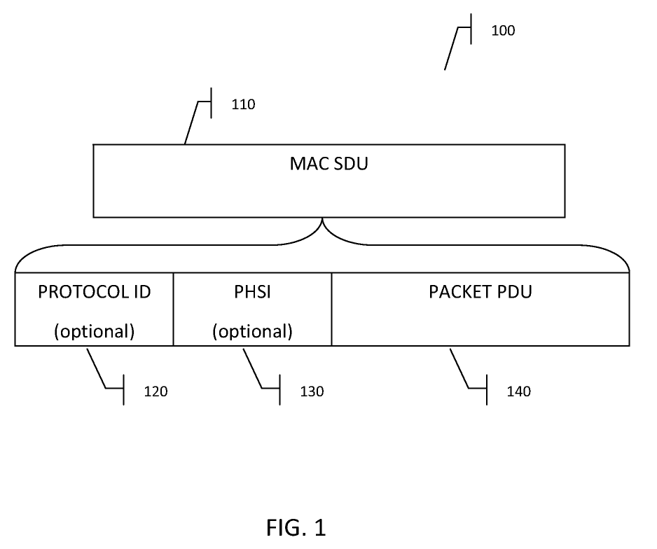

Embodiments of the present invention provide a MAC SDU format as shown in FIG. 1 generally as 100. Once classified and associated with a specific MAC connection, higher layer PDUs 140 shall be encapsulated in the MAC SDU 110 format. The 8-bit PHSI (payload header suppression index) field 130 shall be present when a PHS rule has been defined for the associated connection.

Embodiments of the present invention may provide an 8-bit Protocol. ID field shall be present when a multiprotocol flow is defined for the associated connection. Support for multiple protocols on the same flow are set forth according to embodiments of the present invention. In order to transport several types of protocols, over the same MAC connection the multiprotocol flow can be used.

The receiver must identify the protocol to correctly forward the service data unit (SDU). For instance, but not by way of limitation, if the information carried by the SDU is a RoHC packet, it should be forwarded to the RoHC decompressor. The receiver does this according to the Protocol ID field which is the first byte of a Multiprotocol flow connection as depicted in FIG. 1. Once the protocol type of an incoming packet is determined, the appropriate classification rules are applied to the packet and the correct service flow is identified. It is then optionally forwarded to the header suppression mechanism (PHS or RoHC) and then mapped to the MAC SAP using the format described herein. The protocol ID content is set by the transmitter by the protocol identified before the classification rules were applied and according to the Table below.

| Protocol ID | Meaning |
|---|---|
| 0 | Ethernet MAC Service |
| 1 | MPLS |
| 2 | PPP |
| 3 | Raw IP |
| 4 | IPv4 |
| 5 | RoHC |
| 6 | IPv6 |
| 7 | ECRTP |
| 6 . . . 256 | Reserved |

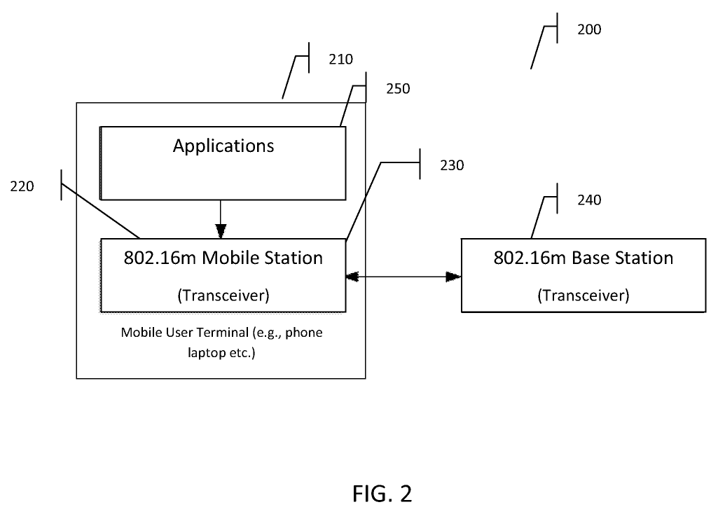

Looking now at FIG. 2 at 200 is provided a system diagram according to embodiments of the present invention, in which a mobile station (MS) 220 and applications 230 are collocated in a mobile user terminal 210, such as, but not limited to mobile phone, laptop, PDA etc. MS and a base station (BS—also referred to herein as an access point (AP)) 240 may communicate wirelessly. Both MS and BS may utilize transceivers that operate according to the embodiments set forth herein.

A further embodiment of the present invention provides a computer readable medium encoded with computer executable instructions, which when accessed, cause a machine to perform operations comprising supporting multiple protocols in a wireless network, such as, but not limited to, a network operating according to an Institute for Electronic and Electrical Engineers IEEE) 802.16 standard by adding a new convergence sub layer (CS) type in which an extra field is added to an 802.16 service data unit (SDU) to indicate which higher layer protocol is carried in a 802.16 SDU payload.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

We claim:

1. A method for supporting multiple protocols in wireless networks, comprising:
adding a protocol type field to enable sending several different protocols over the same flow.

2. The method of claim 1, wherein said network conforms to the standards adopted by the Institute for Electronic and Electrical Engineers (IEEE) in an 802.16 standard.

3. The method of claim 2, wherein said protocol type field is added to a packet in said 802.16 for a new type of convergence sub layer (CS).

4. The method of claim 3, further comprising adding said protocol type and its parsing field to an extra field in an 802.16 service data unit (SDU).

5. A method of supporting multiple protocols in a wireless network operating according to an Institute for Electronic and Electrical Engineers IEEE) 802.16 standard, comprising:
adding a new convergence sub layer (CS) type in which an extra field is added to an 802.16 service data unit (SDU) to indicate which higher layer protocol is carried in a 802.16 SDU payload.

6. A method according to claim 5, wherein once classified and associated with a specific medium access control (MAC) connection, higher layer protocol data units (PDUs) are encapsulated in a MAC SDU format.

7. The method according to claim 6, wherein an 8-bit payload header suppression index (PHSI) field is present when a PHS rule has been defined for an associated connection and an 8-bit Protocol ID field shall be present when a multiprotocol flow is defined for an associated connection.

8. The method according to claim 7, further comprising a receiver operating in said 802.16 network identifying a protocol to correctly forward said SDU, and wherein once said protocol type of an incoming packet is determined, appropriate classification rules are applied to said packet and a correct service flow is identified.

9. The method of claim 8, wherein protocol ID content is set by a transmitter operating in said 802.16 network by said protocol identified before said classification rules are applied.

10. A mobile station (MS), comprising:
a transceiver adapted to support multiple protocols in a wireless network operating according to an Institute for Electronic and Electrical Engineers IEEE) 802.16 standard by adding a new convergence sub layer (CS) type in which an extra field is added to an 802.16 service data unit (SDU) to indicate which higher layer protocol is carried in a 802.16 SDU payload.

11. A MS according to claim 10, wherein once classified and associated with a specific medium access control (MAC) connection, higher layer protocol data units (PDUs) are encapsulated in a MAC SDU format.

12. The MS according to claim 11, wherein an 8-bit payload header suppression index (PHSI) field is present when a PHS rule has been defined for an associated connection and an 8-bit Protocol ID field shall be present when a multiprotocol flow is defined for an associated connection.

13. The MS according to claim 12, further comprising a receiver operating in said 802.16 network identifying a protocol to correctly forward said SDU and once said protocol type of an incoming packet is determined, appropriate classification rules are applied to said packet and a correct service flow is identified.

14. The MS of claim 13, wherein protocol ID content is set by a transmitter operating in said 802.16 network by said protocol identified before said classification rules are applied.

15. A computer readable medium encoded with computer executable instructions, which when accessed, cause a machine to perform operations comprising:
supporting multiple protocols in a wireless network operating according to an Institute for Electronic and Electrical Engineers IEEE) 802.16 standard by adding a new convergence sub layer (CS) type in which an extra field is added to an 802.16 service data unit (SDU) to indicate which higher layer protocol is carried in a 802.16 SDU payload.

16. The computer readable medium encoded with computer executable instructions of claim 15, wherein once classified and associated with a specific medium access control (MAC) connection, higher layer protocol data units (PDUs) are encapsulated in a MAC SDU format.

17. The computer readable medium encoded with computer executable instructions of claim 16, wherein an 8-bit payload header suppression index (PHSI) field is present when a PHS rule has been defined for an associated connection and an 8-bit Protocol ID field shall be present when a Multiprotocol flow is defined for an associated connection.

18. The computer readable medium encoded with computer executable instructions of claim 11, further comprising further instructions to control a receiver operating in said 802.16 network that identifies a protocol to correctly forward said SDU and once said protocol type of an incoming packet is determined, appropriate classification rules are applied to said packet and a correct service flow is identified.

19. The computer readable medium encoded with computer executable instructions of claim 11, wherein protocol ID content is set by a transmitter operating in said 802.16 network by said protocol identified before said classification rules are applied.
